(19) United States
(12) Patent Application Publication
(10) Pub. No.: US 2016/0267566 A1
(43) Pub. Date: Sep. 15, 2016

(54) SYSTEMS AND METHODS FOR MANAGING AN INVENTORY OF DIGITAL GIFT CARD ASSETS

(71) Applicants: Mark Levitt, Foster City, CA (US); James McMillian, Vredehoek (ZA); Michael Paul Brewer, Burlingame, CA (US); Vinodan K. Lingham, Los Altos, CA (US); George Lucas Bowen, San Ramon, CA (US); Krisan Ramesh Nichani, San Francisco, CA (US)

(72) Inventors: Mark Levitt, Foster City, CA (US); James McMillian, Vredehoek (ZA); Michael Paul Brewer, Burlingame, CA (US); Vinodan K. Lingham, Los Altos, CA (US); George Lucas Bowen, San Ramon, CA (US); Krisan Ramesh Nichani, San Francisco, CA (US)

(21) Appl. No.: 15/072,125

(22) Filed: Mar. 16, 2016

Related U.S. Application Data
(63) Continuation-in-part of application No. 14/658,097, filed on Mar. 13, 2015.

(51) Int. Cl. G06Q 30/06; G06Q 20/34

(52) U.S. Cl. CPC G06Q 30/0617; G06Q 30/0635; G06Q 30/0641; G06Q 20/342

(57) ABSTRACT

Disclosed herein are certain embodiments of systems and methods for inventory management of digital gift cards purchased from a variety of merchants, stored on a server database and resold indirectly to customers. A server would obtain an economic order quantity of gift cards from assorted merchants to generate a digital inventory. These codes may remain entirely private between the server and the merchant from which they were bought. The server would additionally sell merchant credits to customers using a web application. The digital inventory would be used to fulfill sales of merchant credit to customers.

### RELATED APPLICATIONS

This application claims priority to U.S. Ser. No. 14/658,097, titled “SYSTEM AND METHOD FOR ESTABLISHING A PUBLIC LEDGER FOR GIFT CARD TRANSACTIONS,” and to U.S. Ser. No. 62/133,247, titled “SYSTEM AND METHOD FOR MANAGING AN INVENTORY OF DIGITAL GIFT CARD ASSETS,” both filed on Mar. 13, 2015, the contents of both of which are hereby incorporated by reference.

### FIELD OF THE DISCLOSURE

The present disclosure relates to management of a digital inventory. The present disclosure more specifically relates to managing digital gift cards.

### INCORPORATION BY REFERENCE

U.S. Ser. No. 13/831,365, titled “SYSTEMS AND METHODS FOR DIGITAL GIFT CARD SELECTION,” filed on Mar. 14, 2013, is incorporated by reference in its entirety and for all purposes to the same extent as if the patent application was specifically reprinted in this specification.

### BACKGROUND

Consumers looking to purchase gift cards from specific merchants often encounter gift card sales systems that were designed for physical distribution methods and have yet to adapt to faster means. Accordingly, some merchants commonly run out of debit codes to distribute to customers, or some merchants have unreliable servers for procuring gift cards. Further merchants provide their gift cards in many different formats. Means for alleviating these issues are therefore useful.

### SUMMARY

An embodiment of the present disclosure includes systems and methods for inventory management of digital gift cards purchased from a variety of merchants, stored on a server database and resold indirectly to customers. One example of the systems and methods would primarily utilize a server with Internet connectivity. On the server would be a database stored containing a digital inventory of gift card redemption codes corresponding to a variety of amounts and a variety of merchants. Customers of the server's digital inventory would not necessarily ever see the actual gift card redemption codes. These codes may remain entirely private between the server and the merchant from which they were bought. The server would additionally have a purchasing agent for purchasing the gift card redemption codes from the variety of merchants. The system would further include a customer graphic user interface (GUI) hosted by the server and displayed to customers on personal web-enabled devices which would enable the customers to obtain a credit for a specific merchant from the server. The server would additionally include a credit fulfillment module which would communicate with merchants whom customers visited and wanted to redeem the credit sold by the server through the customer GUI. The credit fulfillment module makes the connection for the merchant between the customer and one or more of the gift card redemption codes contained within the digital inventory. Finally, the server would include a database manager for optimizing the digital inventory with an economic order quantity of gift card redemption codes accounting for time-variable demand.

Variations on the present disclosure would include, among other aspects, multiple permutations of connecting credits purchased by customers to gift card redemption codes purchased by the server.

### BRIEF DESCRIPTION OF THE FIGURES

FIG. 1 illustrates the user interface of a sample blockchain system adapted for gift card use.

FIG. 2A illustrates a sample transaction record on the blockchain where a user purchases a gift card.

FIG. 2B illustrates a sample transaction record on the blockchain where a user transfers a gift card to another user.

FIG. 2C illustrates a sample transaction record on the blockchain where a user expends gift funds at a specified merchant.

FIG. 2D illustrates a sample transaction record on the blockchain where a user claims gift funds at a specified merchant.

FIG. 3 illustrates communication and data transfer between entities using a mobile-based gift card exchange adapted to a blockchain publisher system.

FIG. 4 illustrates a gift card transfer between accounts.

FIG. 5 is a flow chart of a published transfer of a gift card from one user account to a second user account.

FIG. 6 is a flow chart illustrating the method for publishing numerous types of transactions in a mobile-based gift card exchange.

FIG. 7 is a time flow chart illustrating a sample order of operations for gift card transactions.

FIG. 8A is an example graph demonstrating how to find an economic order quantity, according to an embodiment of the disclosure.

FIG. 8B is an example graph illustrating ordering cycles for economic order quantity, according to an embodiment of the disclosure.

FIG. 9 is an example flow chart for determining economic order quantity for a digital inventory, according to an embodiment of the disclosure.

FIG. 10 is an example diagram illustrating digital inventory generation, according to an embodiment of the disclosure.

FIG. 11 is an example time flow chart illustrating a sample order of operations for gift card transactions, according to an embodiment of the disclosure.

FIG. 12 is an example assignment diagram illustrating various means for assigning assets to credits, according to an embodiment of the disclosure.

FIG. 13 is an example illustration of communication flow of an embodiment of a method according to an embodiment of the disclosure.

FIG. 14 is an example flowchart illustrating the method of FIG. 6, according to an embodiment of the disclosure.

The detailed description is set forth below with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa. Various illustrative embodiments are discussed herein. These and other example embodiments of the disclosure will be described in more detail hereinafter through reference to the accompanying drawings. The drawings and the corresponding description are provided merely for illustration and are not intended to limit the disclosure in any way. It should be appreciated that numerous other embodiments, variations, and so forth are within the scope of this disclosure.

### DETAILED DESCRIPTION

Gift cards in a purely electronic system do not use physical cards. The term, “gift card,” is a misnomer, though still used to express a concept. In actual fact gift cards are no more than numerical codes with an associated value to a given corporation or entity. In using a mobile device enhanced gift card system, such as the Gyft mobile application available on iOS or Android, or another operating system of similar character, gift “cards” are displayed to users on their mobile devices, though no actual “card” exists. The displayed card is simply a digital artifact that the application is directed to present to the user. The user's device does not include additional code indicating the presence of the card—rather the evidence of “card” ownership exists merely on the application's host server and the host server directs the mobile application to display the “card” for the user. Reference to a “gift card” in this context merely refers to the concept of reasonably fixed debit with a specified entity. A blockchain is a public ledger. The public ledger includes all such transactions that have ever been executed. The blockchain is constantly growing as ‘completed’ blocks are added with a new set of recordings. The blocks are added to the blockchain in a linear, chronological order, like a chain.

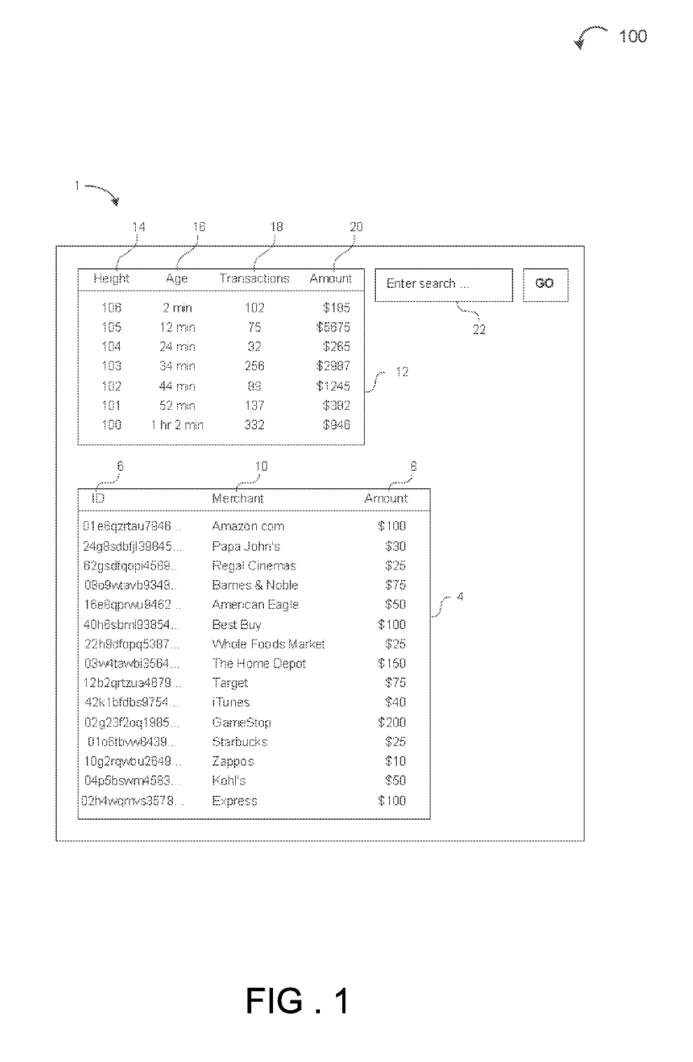

Referring now to FIG. 1, FIG. 1 is a representation of a blockchain interface 2. The blockchain interface 2 is a web interface that appears to users by use of a web browser such as Microsoft Internet Explorer, Mozilla Firefox, Apple Safari, Google Chrome, or another suitable program known in the art. The blockchain interface 2 will include a transaction stream 4. The transaction stream 4 displays records of transactions on the network and updates actively, in real-time, as users of the network perform transactions. The transaction stream 4 would include a transaction ID 6, the transaction ID 6 could be a hash code, or reference to a token or digital construct. The transaction stream 4 further includes the amount for which the transaction concerns (“amount”) 8, and the merchant for which the gift card is with (“merchant”) 10. The blockchain interface 2 also includes a block stream 12. The block stream 12 updates in a similar fashion to the transaction stream 4; however the block stream 12 displays data concerning collections of transactions, which are compiled into “blocks.” Blocks can be a collection of all transactions is a given period, or they might be sorted differently, such as by merchant 10. Alternatively blocks could be compiled or by reference to a particular token or other digital construct. The data presented in the block stream 12 includes a block height 14 designation number which grows linearly as blocks are added to the chain, the age 16 of each block, the number of transaction records 18 included in each block, and the block amount 20 which denotes the amount of money transacted in each block. The blockchain interface 2 would additionally include a search bar 22 which a user would use to search for particular transaction records or blocks.

The blockchain interface 2 illustrated in FIG. 1 is merely illustrative. Other elements could be included in the interface such as including the age of a given transaction in the transaction stream 4, sorting blocks by merchant 10, or presenting information in another preferred manner. Further, additional analytical charts could be presented through additional web interface pages. Such analytical charts could include data such as trends concerning how long users of accounts held on to tokens, data concerning specific merchant trends, or other chartable data relevant to gift card transactions.

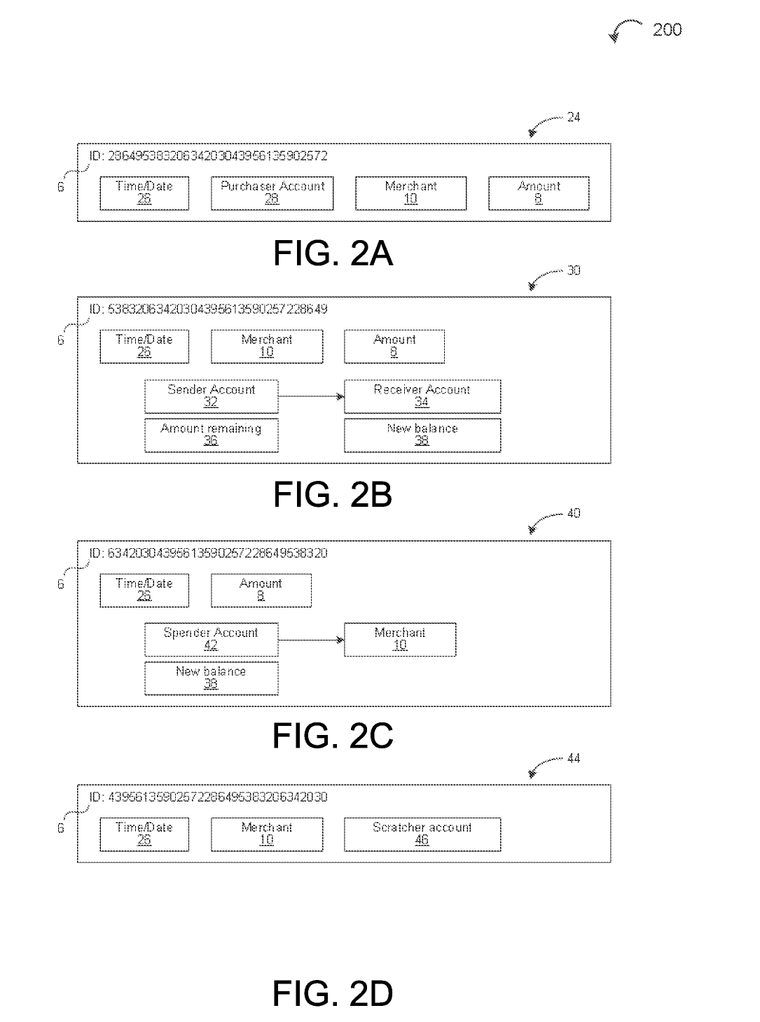

Referring now to FIG. 2A, 2B, 2C, and 2D, the 2 series of FIGS. illustrates different kinds of transaction records associated with differing transactions. FIG. 2A is a gift card purchase record 24 which would include a transaction ID 6, a time stamp 26, a purchaser account 28 which identifies who purchased the gift card by a real name, or an account name pseudonym. The gift card purchase record 24 further includes reference to the merchant 10 and the amount 8.

FIG. 2B is a gift card transfer record 30 which would include a transaction ID 6, a time stamp 26, a sender account 32 which identifies the grantor of the card the gift card by a real name, or an account name pseudonym. Similarly, the gift card transfer record 30 has a receiver account 34 which is identified in the same manner as the sender account 32. Additionally, associated with the sender account 32, the remaining balance 36 on the sender's account will be displayed along with the new balance 38 of the receiver's account. The gift card transfer record 30 further includes reference to the merchant 10 and the amount 8.

FIG. 2C is a gift card expenditure record 40 which would include a transaction ID 6, a time stamp 26, a spender account 42 which identifies who is expending the funds of the gift card by a real name, or an account name pseudonym. The gift card expenditure record 24 further includes reference to the merchant 10, the amount 8 expended and the new balance 38 of the account.

FIG. 2D is a gift card claim record 44 which denotes that a given account wishes to begin receiving authentication codes (discussed below). Gift card claim records 44 would include a transaction ID 6, a time stamp 26, a scratcher account 46 which identifies who claims the gift card by a real name, or an account name pseudonym. The gift card claim record 44 further includes reference to the merchant 10. The transaction records illustrated in the 2 series of FIGS is merely illustrative. Other elements could be included as necessary.

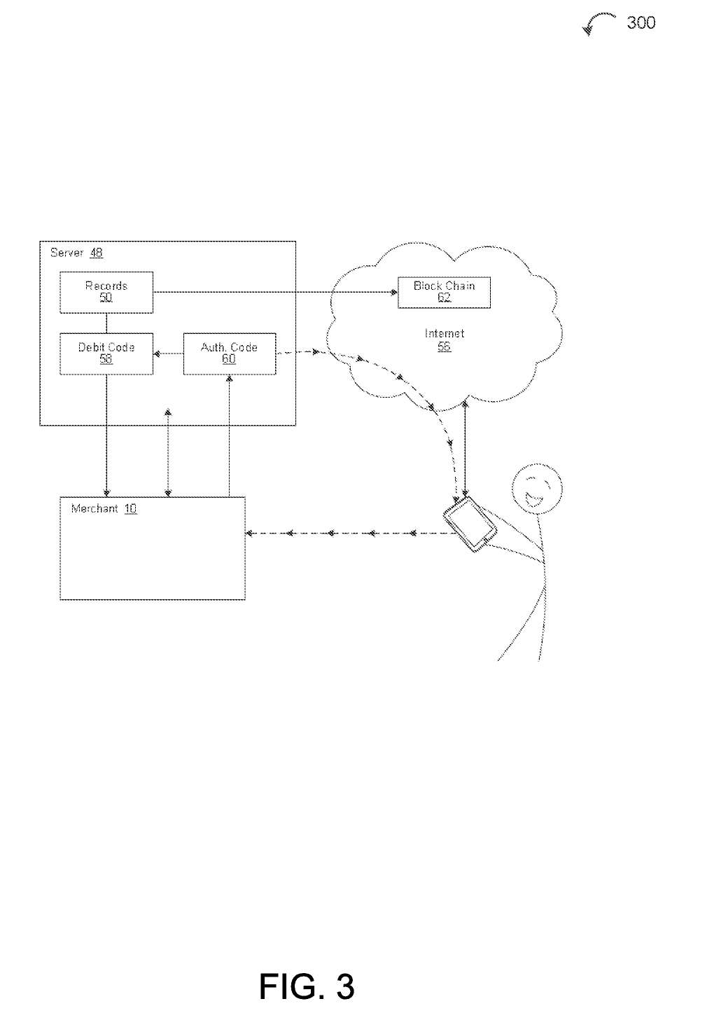

Referring to FIG. 3, FIG. 3 is illustrates communication and data transfer between entities using a mobile-based gift card exchange adapted to a blockchain publisher system. The system centers around a web server 48 the web server 48 stores business records 50. Customers 52 of the system would use web-enabled devices 54 to contact the server 48 through the Internet 56 and purchase gift cards for a given merchant 10. Web-enabled device 54 would include mobile phones, laptop computers, tablet computers, desktop computers, or another suitable device capable of contacting a web server.

The server 48 acquires a gift card on behalf of the customer 52, from a merchant 10. That debit card is manifested by a debit code 58. The debit codes 58 may be used For the system to work efficiently, it is not necessary for the server 48 to obtain debit codes 58 individually each time a customer 52 orders. A given debit code 58 may cover the orders of multiple customers 52, or inversely, multiple debit codes 58 may cover a single order from a single customer 52. The debit codes 58 on the server 48 may predate an order by a customer 52 or the debit codes 58 may be acquired in response to an order by a customer 52.

Customers 52 would not actually see or have direct access to debit codes 58. Instead, customers 52 see variable authentication codes 60. Customers 52 who have purchased a gift card from the server 48, will have an account stored on the server 48 in server records 50. This account could be represented by a token, or some other digital construct which is associated with the customer's account stored in records 50. As an optional step the system would make use of a “scratching” feature where a customer 52 would indicate to the server 48 that a purchased gift card should be claimed. Before the “scratch” occurred, the server 48 would not have to assign a debit code 58 to the customer 52. Though the records 50 would should that the customer 52 had a debit account of a given monetary value, that account would not have to be assigned a code to enable actually expending the monetary value of the account until the customer 52 scratched, or claimed the gift card. Once an gift card is claimed, the customer 52 receives periodic variable authentication codes 60 through the Internet 56.

Variable authentication codes 60 change on a regular basis, such that no code is usable forever. The lifetime of a variable authentication code 60 could be measured in seconds or minutes. When one variable authentication code 60 “dies,” another is issued. Optionally, to reduce purchase failure, the lifetime of variable authentication codes 60 could overlap, such that in a given moment it would be possible that two variable authentication codes 60 would be valid. A alternative model for variable authentication codes 60 issuance would involve simply issuing a variable authentication code 60 with a set lifetime anytime a customer 52 accessed their account on the server 48 while issuing no variable authentication codes 60 while a customer's account remained dormant.

In use, a variable authentication code 60 can be used at a specified merchant 10. The merchant 10 then communicates the variable authentication code 60 supplied by the customer 52 to the server 48. Should the variable authentication code 60 supplied by the customer 52 match the code 60 that is “live” on the server 48, the server 48 will indicate to the merchant 10 one or more debit codes 58 to use to fulfil the customer's 52 order.

Alternatively to expending gift card monetary value at a merchant 10, customers 52 can exchange gift cards with one another. The transaction, along with merchant expenditure transactions would be recorded in records 50, and the records 50 would be published on the internet 56 to a blockchain 62.

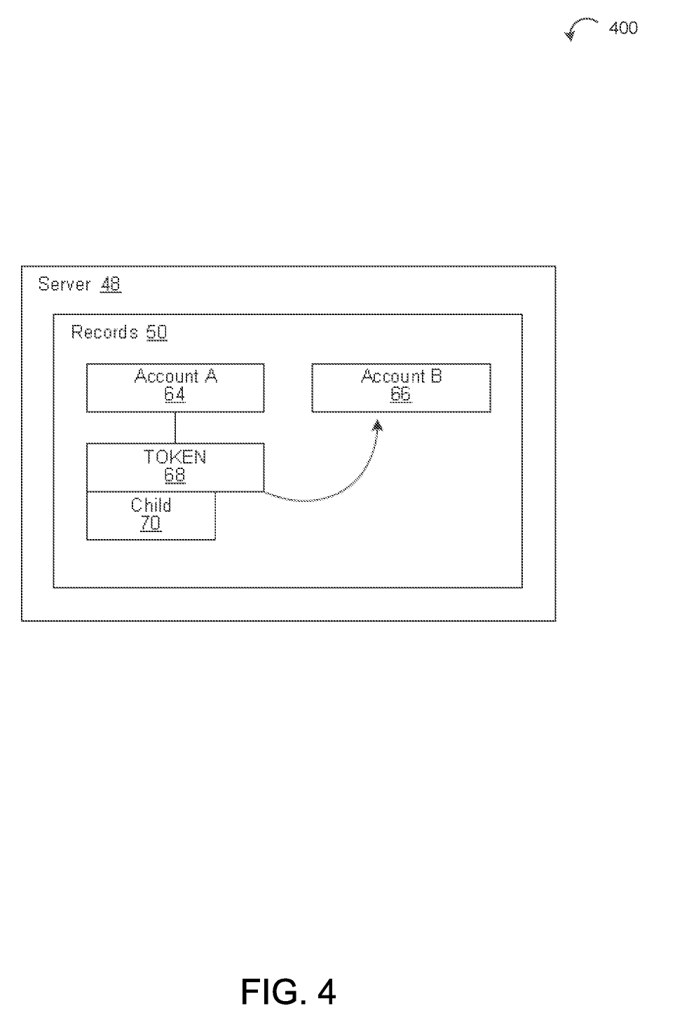

Referring now to FIG. 4, with continued reference to FIG. 3, FIG. 4 illustrates a gift card transfer between accounts. On the server 48, stored in records 50, are user accounts A 64 and user account B 66. In order to record value on a blockchain 62, a token 68 or some other digital contract would be used. When user account A 64 intends to give a gift card to user account B 66, a token 68 is transferred from user account A 64 to user account B 66. The transfer of the token 68 is published to the blockchain 62. In one embodiment of a token 68, the token 68 is simply an account flag with a unique ID. In a second embodiment of a token 68, the token 68 is a simple record which includes a reference to a single debit code 58 and is used primarily to act as a public reference to the debit code 58 without revealing the debit code 58.

In a third embodiment of a token 68, the token 68 is a dynamic record which serves to keep an accounting of all gift card business conducted by an account. As a dynamic record, the token 68 would keep track of one or more debit codes 58 which are associated with the monetary value owed by a specific merchant to the token holder. Each of these debit codes 58 may be shared over numerous tokens 68. A first token 68a may have 100% interest in a first debit code 58a, and 25% interest in a second debit code 58b, whereas a second token 68b may have the remaining 75% of the interest in the second debit code 58b. Should a user purchase more credit with a given merchant 10, additional debit codes 58 would be added to the token 68. If the token acts as a dynamic record, transferal from user account A 64 to user account B 66 would involve transfer of the entire token 68, or the creation of a child token 70 which contained partial value of the original token 68. A child token 70 would either remain with user account A 64 and the original token 68 would be transferred to user account B 66, or vice-versa.

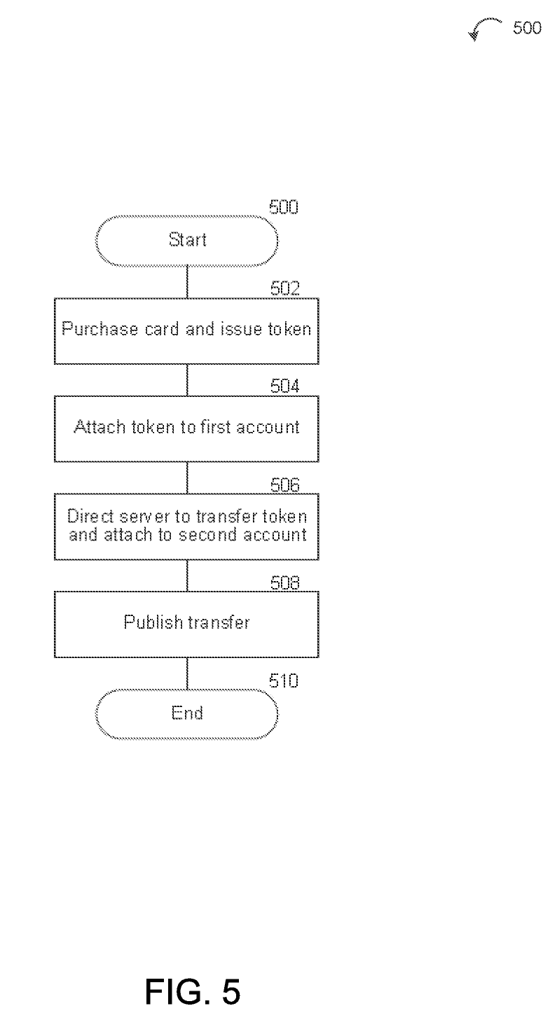

Referring now to FIG. 5, FIG. 5 is a flow chart of a published transfer of a gift card from one user account to a second user account. First, a user of the system will purchase a gift card through an online web server, and the web server will issue a representative token for that gift card (502). The web server then attaches the issued token to the user's account (504). Through the user interface, the user would direct the server to transfer the gift card to another user's account—the transfer of the gift card would transfer the representative token between accounts as well (506). Finally, the token transfer of step 506 will be published online to a blockchain ledger (508).

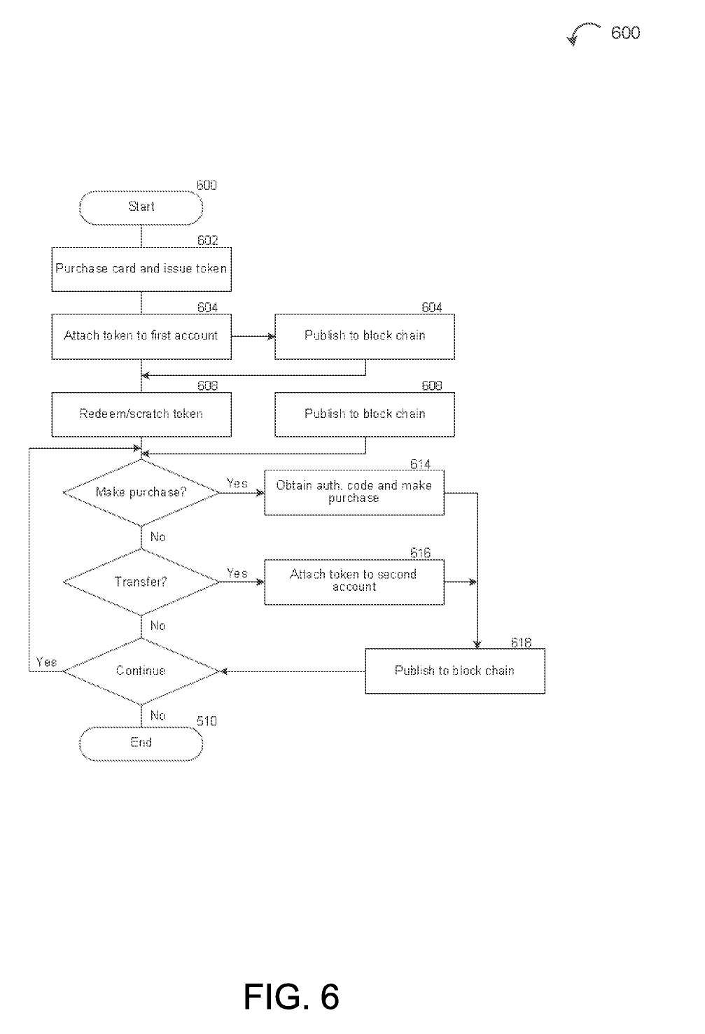

Referring now to FIG. 6, FIG. 6 is a flow chart illustrating the method for publishing numerous types of transactions in a mobile-based gift card exchange. First, a user of the system will purchase a gift card through an online web server, and the web server will issue a representative token 68 for that gift card (602). The web server then attaches the issued token to the user's account (604). When the token is attached to the user's account the server will publish the token generation to a public blockchain ledger (606). The user will eventually claim the purchased gift card. Claiming or “scratching” the gift card could occur immediately after purchase, or as late as when the user intended to redeem the gift card with the merchant. When the gift card is claimed by the user, the server will assign the user one or more debit codes or part of a debit code (608). The assignment of debit code would also be published to the public blockchain, though the debit code itself would not be referenced—rather the debit code itself would be kept private by the server (610). Once a debit code is assigned to the token, the user has the option to make purchases. To make a purchase, the server will send the user an authorization code, the code is used at the merchant. The merchant references the authorization code to the server which provides the assigned debit code to the merchant. The merchant charges to the debit code and the server records the transaction with respect to the token (614). A user can also transfer a token to another user. While FIG. 6 displays the transfer query after the claim step, tokens may optionally be transferred between users before the token is claimed. The token simply switches accounts without having an assigned debit code. Regardless of when the transfer occurs, the server records the transfer (616). With either a merchant charge to an assigned debit code, thereby diminishing a token, or a transfer of a token the server will publish this information to the public blockchain (618).

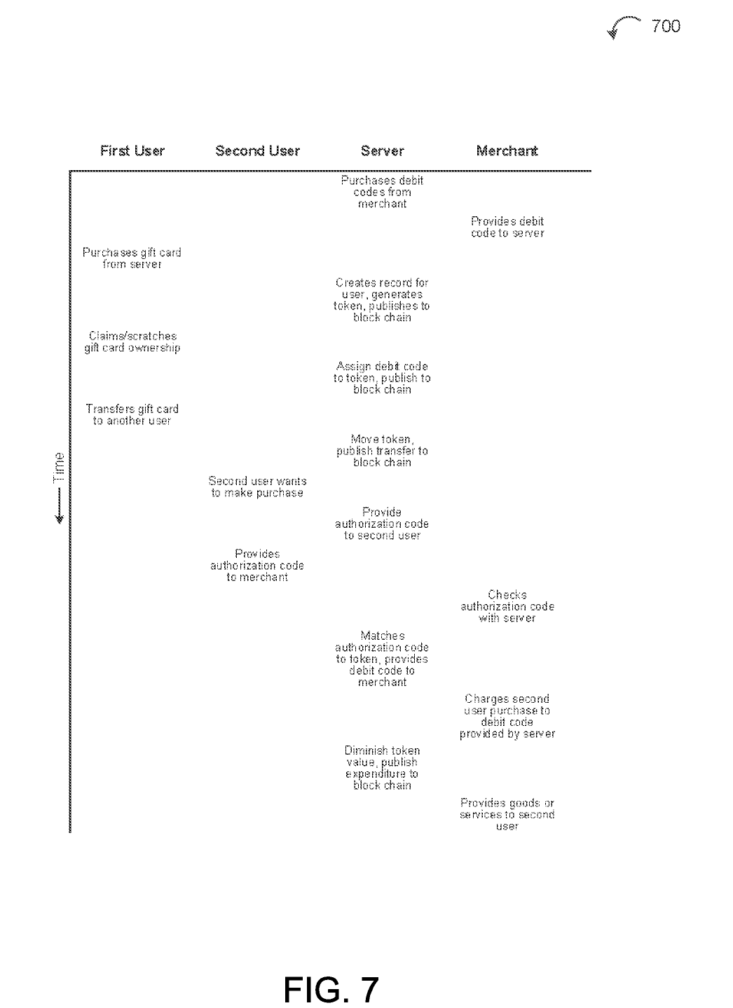

Referring now to FIG. 7, FIG. 7 is a time flow chart illustrating a sample order of operations for gift card transactions. The time flow chart includes four columns, each column representing a party to described transactions. Moving down the chart progresses the transactions in time. The space between actions is not standardized for time, and the time between a given action and the subsequent action could be measured anything between milliseconds and years. Some operations on the time chart could be performed in a different order or not at all—this chart is provided merely to present an illustrative example. The content of the chart is self-explanatory.

In certain embodiments, the server would manage an inventory of debit codes for one or more merchants. The inventory would provide a marketplace for gift cards without requiring the merchant's own infrastructure to be operational in order for the sale of gift cards. The inventory would not necessarily require that a given debit code be entirely used by any one customer. Each debit code could be shared amongst a group of customers, or multiple debit codes could serve to fulfil a single gift card purchase. The server would determine which debit codes were expended, thus it is feasible that a given debit code would only remain with a given customer for a limited period of time before moving the code to assigning a different debit code. As long as the customer's credit with a given merchant was accounted for, the debit codes actually assigned to the customer would be interchangeable.

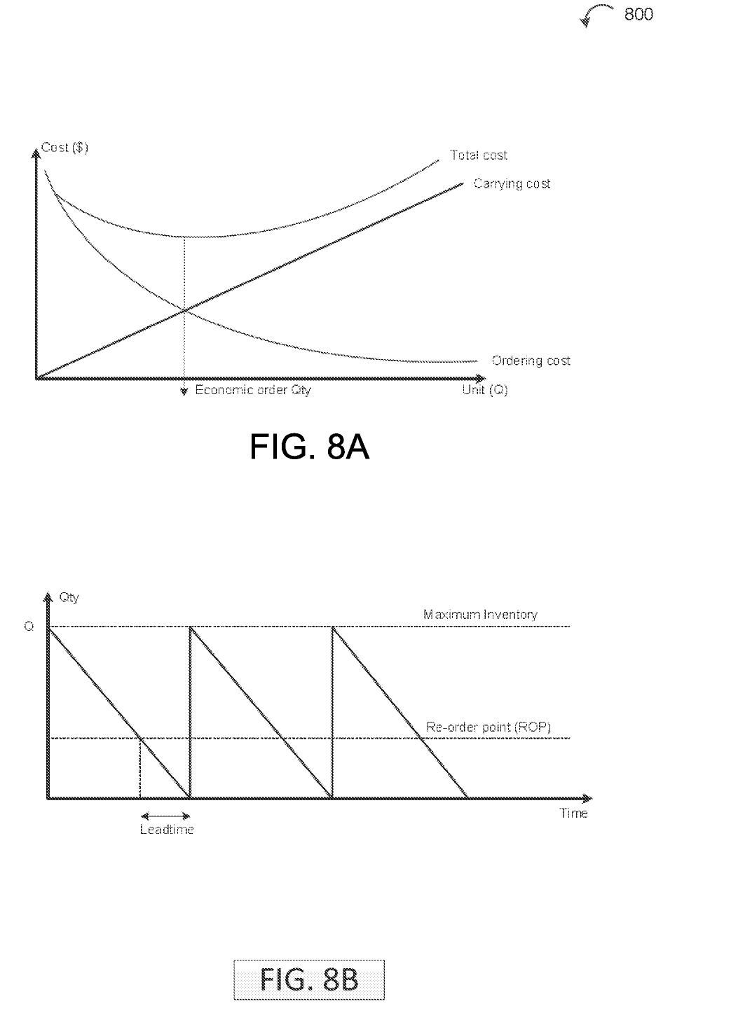

With respect to FIGS. 8-14, the following description details certain embodiments of systems and methods for inventory management of digital gift cards purchased from a variety of merchants, stored on a server database and resold indirectly to customers.

Gift cards in a purely electronic system do not use physical cards. The term, “gift card,” is a misnomer, though still used to express a concept. In actual fact gift cards are no more than alpha-numerical codes with an associated value to a given corporation or entity. In using a mobile device enhanced gift card system, such as the Gyft® mobile application available on iOS® or Android®, or another operating system of similar character, gift “cards” are displayed to users on their mobile devices, though no actual “card” exists.

The displayed card on the application is simply a digital artifact that the application is directed to present to the user. The user's device does not include additional code indicating the presence of the card—rather the evidence of “card” ownership exists merely on the application's host server and the host server directs the mobile application to display the “card” for the user. Reference to a “gift card” in this context may merely refer to the concept of reasonably fixed debit with a specified entity.

The Economic Order Quantity (EOQ) is traditionally the number of units that a company should add to inventory with each order to minimize the total costs of inventory—such as holding costs, order costs, and shortage costs. The EOQ is used as part of a continuous review inventory system in which the level of inventory is monitored at all times and a fixed quantity is ordered each time the inventory level reaches a specific reorder point. The EOQ provides a model for calculating the appropriate reorder point and the optimal reorder quantity to ensure the instantaneous replenishment of inventory with no shortages. EOQ can be a valuable tool for small business owners who need to make decisions about how much inventory to keep on hand, how many items to order each time, and how often to reorder to incur the lowest possible costs.

Referring to FIG. 8A and 8B, FIG. 8A is a graph of an EOQ model and FIG. 8B is a graph for inventory control. The basic EOQ model assumes that demand is constant, and that inventory is depleted at a fixed rate until it reaches zero. At that point, a specific number of items arrive to return the inventory to its beginning level. Since the model assumes instantaneous replenishment, there are no inventory shortages or associated costs.

The cost of inventory under the EOQ model involves a tradeoff between inventory holding costs (the cost of storage, as well as the cost of tying up capital in inventory rather than investing it or using it for other purposes) and order costs (any fees associated with placing orders, such as delivery charges). Ordering a large amount at one time will increase a small business's holding costs, while making more frequent orders of fewer items will reduce holding costs but increase order costs. The EOQ model finds the quantity that minimizes the sum of these costs.

The basic EOQ relationship is generally used with physical goods. As an illustrative example, consider a painter using 3,500 gallons of paint per year, paying $5 a gallon, a $15 fixed charge every time he/she orders, and an inventory cost per gallon held averaging $3 per gallon per year.

The relationship is TC=PD+HQ/2+SD/Q′| where

TC is the total annual inventory cost—to be calculated.

P is the price per unit paid—assume $5 per unit.

D is the total number of units purchased in a year—assume 3,500 units.

H is the holding cost per unit per year—assume $3 per unit per annum.

Q is the quantity ordered each time an order is placed—initially assume 350 gallons per order.

S is the fixed cost of each order—assume $15 per order.

Calculating TC with these values, we get a total inventory cost of $18,175 for the year. Notice that the main variable in this equation is the quantity ordered, Q. The painter might decide to purchase a smaller quantity. If he or she does so, more orders will mean more fixed order expenses (represented by S) because more orders are handles—but lower holding charges (represented by H): less room will be required to hold the paint and less money tied up in the paint. Assuming the painter buys 200 gallons at a time instead of 350, the TC will drop to $18,063 a year for a savings of $112 a year. Encouraged by this, the painter lowers his/her purchases to 150 at a time. But now the results are unfavorable. Total costs are now $18,075. Where is the optimal purchase quantity to be found?

The EOQ formula produces the answer. The ideal order quantity comes about when the two parts of the main relationship (shown above)—“HQ/2” and the “SD/Q”—are equal. We can calculate the order quantity as follows: Multiply total units by the fixed ordering costs ((3,500)($15)) and get 52,500; multiply that number by 2 and get 105,000. Divide that number by the holding cost ($3) and get 35,000. Take the square root of that and get 187. That number is then Q.

In the next step, HQ/2 translates to 281, and SD/Q also comes to 281. Using 187 for Q in the main relationship, we get a total annual inventory cost of $18,061, the lowest cost possible with the unit and pricing factors shown in the example above.

Thus EOQ is defined by the formula: EOQ=square root of 2DS/H. The number we get, 187 in this case, divided into 3,500 units, suggests that the painter should purchase paint 19 times in the year, buying 187 gallons at a time.

EOQ calculations are rarely as simple as this example shows. Here the intent is to explain the main principle of the formula. The small business with a large and frequently turning inventory may be well served by looking around for inventory software which applies the EOQ concept more complexly to real-world situations to help purchasing decisions more dynamically.

EOQ calculations are traditionally directed towards physical goods. Establishing an inventory of digital goods which have a digital distribution method has a few complications to the EOQ calculation. Generally speaking there is no per unit cost associated with a digital good, however with a gift card there is a cost to purchasing credit, and there is a capital opportunity cost for maintaining an inventory.

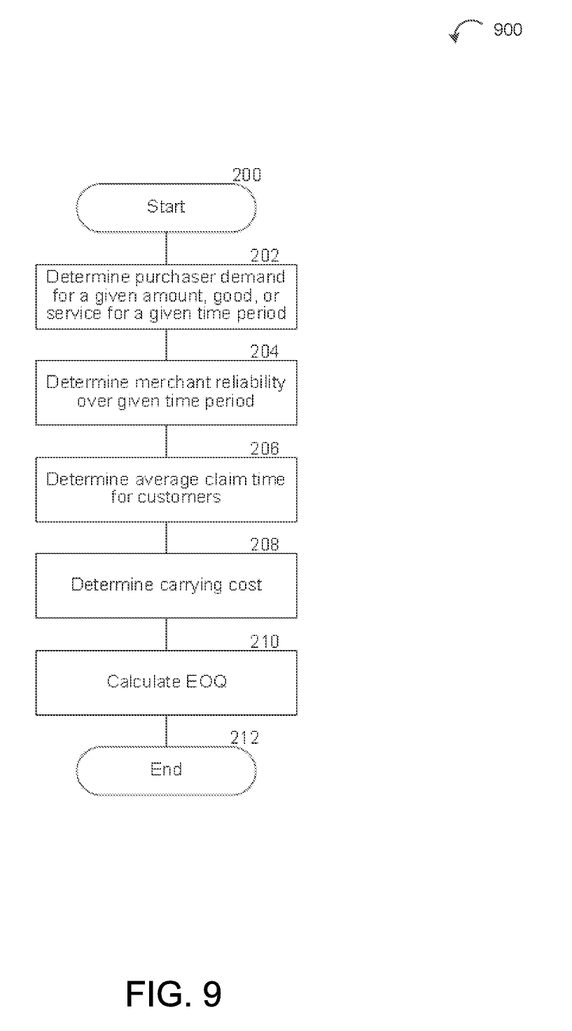

Referring now to FIG. 9, FIG. 9 is a flow chart depicting EOQ generation for digital goods. First the server must determine how much demand exists for a given set of gift cards (202). Demand variables may would include time of year, the specific merchant for which the gift card is for, the denomination of the gift card, or the specific good or service the gift card is for (i.e. one free flight on an airline). The next step is to determine the merchant reliability (204). Merchants may be out of codes to distribute for gift card amounts, or their servers can be down. When either of these events occur, customers cannot purchase gift cards. Accordingly, knowing the frequency in which these events occur for a given merchant is a key variable.

The next variable is to determine the average time between when a customer purchases a gift card, and when someone attempts to redeem that gift card (206). During this period of time there exists merely a floating credit which does not necessarily need to have specific value assigned. This average time would very likely vary by merchant, time of year, and size of the credit. It is likely that a $5 credit for a coffee shop (a daily activity) would be redeemed faster than $25 at a fancy restaurant where an average customer might wait for a special occasion. While unclaimed, the server need not assign any sort of value to the credit the server sells which artificially lowers demand at a given time.

The last variable is to determine the opportunity cost of carrying an inventory (208). While the warehousing costs are negligible because the gift cards only require hard disk space, there is opportunity cost. When the server purchases gift cards from merchants, the capital investment has been spent on the inventory and may not be spent elsewhere. Further, with electronic goods, there would not be the traditional shipping costs, or the traditional “re-order point.” Translating an EOQ calculation to digital goods has similar but very different variables concerning purchasing cost.

Depending on the trade agreements existing between the server and the merchants, it may or may not be preferable to buy larger cards less frequently, or smaller cards more frequently. A better rate may exist with a given merchant if bought all at once, or frequently, or all at a particular time of year. Accordingly, it may be preferable to keep the inventory always at the EOQ amount, or it could be preferable to allow the inventory to deplete, and replace when depleted.

Finally, given all the variables, the server must calculate an EOQ for combination of merchant and denomination/good/service (210). The server knows that EOQ for reliable merchants can be substantially lower than for merchants which are not reliable. The server knows that some times of year will be more popular than others so during those times the EOQ will be higher. The server also knows the trade agreements. Using all these variables, the EOQ at a given period in time for a given merchant/denomination is determinable.

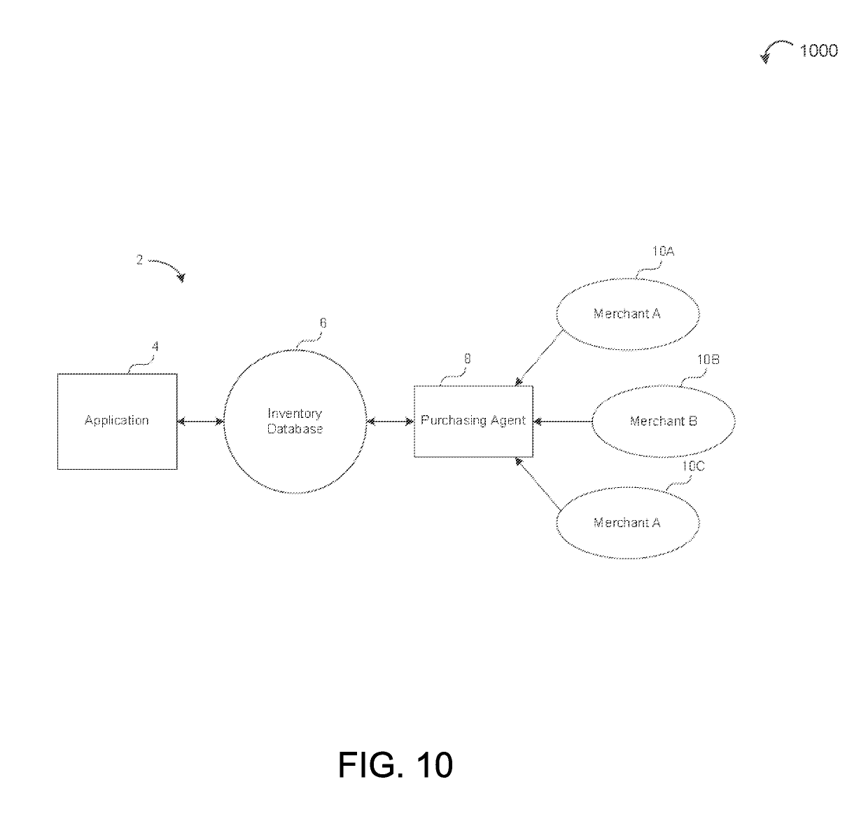

Referring now to FIG. 10, FIG. 10 is a diagram illustrating digital inventory generation. Once an EOQ value has been determined, the orders for the EOQ need to occur. The system would occur largely all on a server 2. The server would have a customer application 4, an inventory database 6 and a purchasing agent 8 for contacting merchants 10. The diagram depicts three merchants, A, B and C 10.

The merchants 10 are not contained on the server 2 and would each have their own servers (not pictured). The purchasing agent 8 would contact each of the merchants A-C 10 and order a number of gift cards to populate the inventory database 6. The inventory database 6 would maintain the records separately for each merchant. Merchants 10 often have differing formats for gift codes. At the time of writing, the following merchants formatted their gift codes like so:

Whole Foods: 6362642080010885;

Gap: 6003868115484127;

Skype: SKYPE-7D8EU-4334W-AUGP6-BTVU6; and

Target: 041300756732843, PIN: 50203037.

When customers of the server 2 would buy credit with the merchants A-C 10 from the server 2, the application 4 would issue a standardized credit code (SCC) which would conform to a single format regardless of how gift codes were generated by the merchant 10.

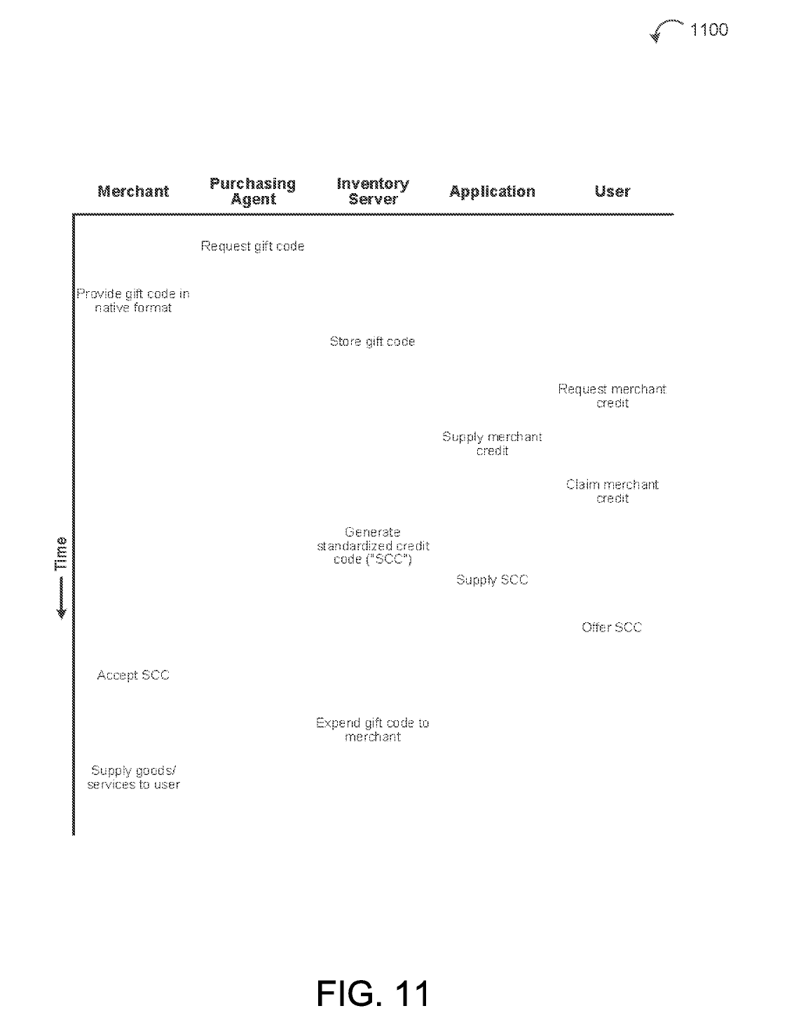

Referring now to FIG. 11, FIG. 11 is a time flow chart illustrating a sample order of operations for gift card transactions. The time flow chart includes five columns, each column representing a party to described transactions. Moving down the chart progresses the transactions in time. The space between actions is not standardized for time, and the time between a given action and the subsequent action could be measured anything between milliseconds and years. Some operations on the time chart could be performed in a different order or not at all—this chart is provided merely to present an illustrative example. The content of the chart is self-explanatory.

In certain embodiments, the server would manage an inventory of gift codes for one or more merchants. The inventory would provide a marketplace for gift cards without requiring the merchant's own infrastructure to be operational in order for the sale of gift cards. The inventory would not necessarily require that a given gift code be entirely used by any one customer. Each gift code could be shared amongst a group of customers, or multiple gift codes could serve to fulfill a single gift card purchase.

The server would determine which gift codes were expended; thus, it is feasible that a given gift code would only remain with a given customer for a limited period of time before moving the code and assigning a different gift code. As long as the customer's credit (represented by a standardized credit code) with a given merchant was accounted for, the gift codes actually assigned to the customer would be interchangeable.

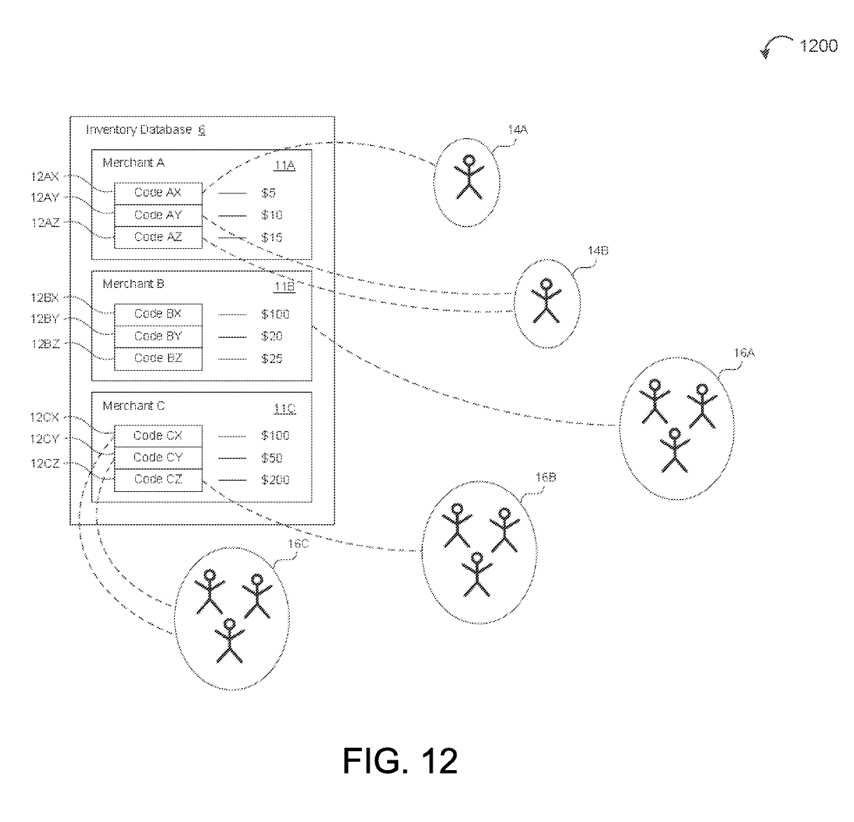

Referring now to FIG. 12, FIG. 12 is and assignment diagram illustrating various means for assigning assets to credits. Given the inventory database 6, having inventory entries for Merchants A, B and C 11. Merchant entry A 11 contains gift codes X, Y and Z 12. In the simplest case, the inventory database could assign a gift code on a 1 to 1 basis with a customer. Imagine customer A 14 has purchased a standardized credit code (SCC) for merchant A 10 from the server valued at $5; the inventory database could assign gift code 12AX which has a $5 value with merchant A 10 to customer A 14.

In another example, multiple gift codes could be assigned a single customer. Imagine customer B 14 acquired $25 value in SCC for merchant B 10 from the server. This value could have come all at once or on multiple occasions. The inventory database 6 could assign gift coeds 12AY and 12AZ to customer B 14 which have a $10 and $15 value respectively.

In another example, a collection of codes could be assigned to a group of customers. Imagine that amongst group A 16, the members of the group 16 have combined SCCs for merchant B 10 adding to $145 (or even more). The inventory database could assign gift codes 12BX, 12BY, and 12BZ all to group A 16 to be diminished as the group individually redeems their credit. Further, based upon the assumption that the members of group A 16 would not immediately spend all of their credit, the gift codes assigned to the group would not necessarily have to amount to the total value of group A's 16 combined SCC value.

In another example, a single code could be assigned to a group of customers. Imagine that amongst group B 16, the members of the group 16 have combined SCCs for merchant C 10 adding to $200. The inventory database 6 could assign gift code 12CZ to cover all attempts to redeem the SCCs of group B 16 up to the individual values of each SCC for each member of the group 16.

In another example, a gift code could be revoked from customers and replaced with another code. Imagine that group C 16 has amongst the members $50 credit with merchant C and that code 12CY has been assigned to group C 16 to cover the credit. Later, group C 16 purchases more credit and now has $100. The inventory database 6 could revoke code 12CY and instead assign code 12CX.

These examples have generally all covered credits sold by the server and gift codes being matched on a 1 to 1 basis for value. This does not necessarily have to be the case. Some value can float whereby there does not necessarily need to ever have been a gift code to support the value of a SCC. At least, there does not need to be a gift code to support the SCC value until a customer attempts to redeem the SCC.

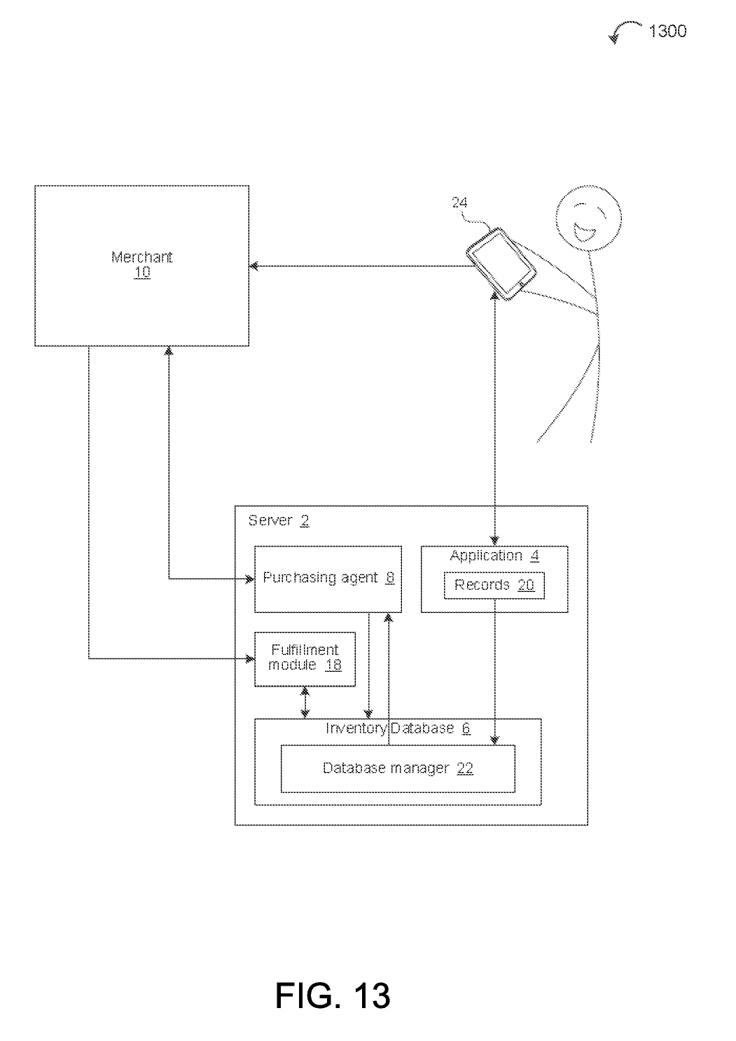

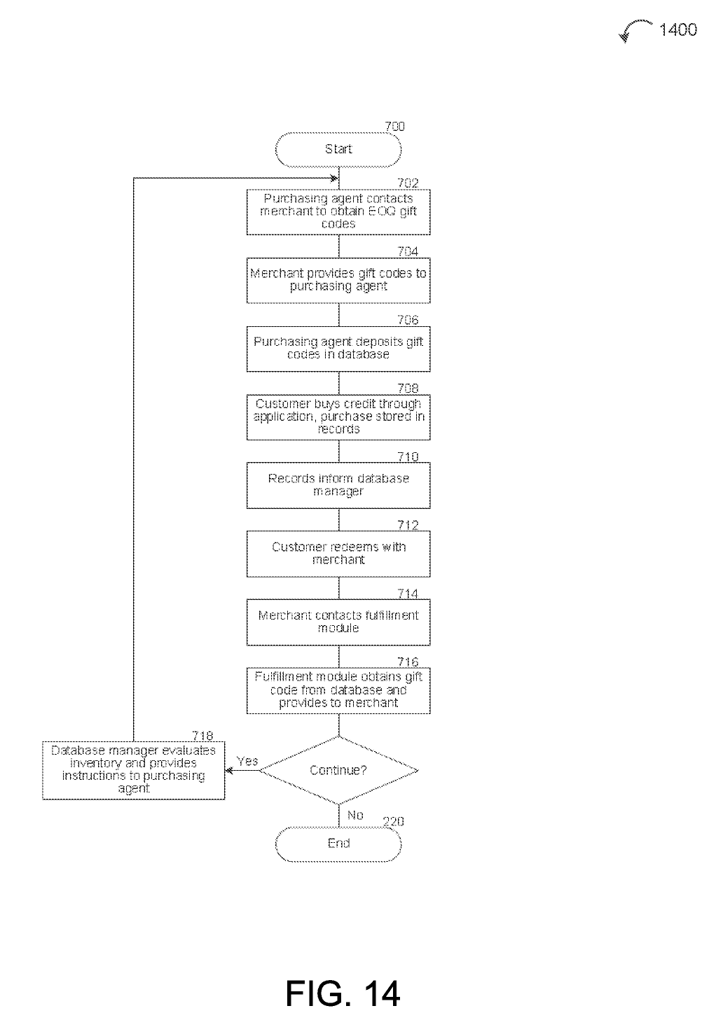

Referring now to FIGS. 13 and 14, FIGS. 13 and 14 illustrate communication flow of an embodiment of the method of present disclosure. The server 2 includes several modules including a customer application 4, an inventory database 6, a purchasing agent 8, and a fulfillment module 18. The application 4 further stores customer records 20. The inventory database additionally includes a database manager 22. The application 4 communicates to and displays a GUI on customer devices 24.

The method of network communication begins where the purchasing agent 8 of the server 2 contacts a merchant 10 and obtains an EOQ of gift codes (702). The merchant 10 then provides the gift codes to the purchasing agent 8 (704). The purchasing agent 8 then deposits the acquired gift codes in the inventory database 6 (706).

Later, a customer uses a personal device 24 with the server's 2 application 4 to purchase credit with the merchant 10 (708). The application 4 then makes a record of the customer purchase in the customer records 20. The customer records 20 inform the database manager 22 such that the database manager can adequately assign gift code value to sold credit (710). The customer records 20 additionally inform the database manager 22 about customer demand to more adequately obtain the EOQ values that should be used by the purchasing agent 8 in performing assigned duties.

Subsequently, the customer will attempt to redeem the credit purchased through the application 4 with the merchant 10 (712). The merchant 10 will then contact the server's 2 fulfillment module 18 (714). The merchant 10 will supply the fulfillment module 18 with whatever evidence the customer has of the purchase from the application 4 from step 708. The fulfillment module 18 then matches the merchant submission to one or more chosen gift codes to complete the customer's purchase (716). If the system continues, the database manager 22 evaluates the remaining inventory 6 and provides further instructions to the purchasing agent 8 (718).

The examples in the disclosure above serve merely as illustrative examples. Methods recited could be conducted in any order that makes sense, communicative action between objects could occur in reverse where applicable or more or less frequently than disclosed. Objects which are depicted in the figures as a part of a greater object could in part or in whole perform the duties of the greater object. Conversely, greater objects could adopt the duties of the subordinate object. Where specific values are referenced, other values could be inserted in such a manner which is not wholly contradictory to the whole disclosure.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

The claimed invention can include:

1. A system for inventory management of digital gift cards purchased from a variety of merchants, stored on a server database and resold indirectly to customers comprising:
a server, the server having Internet connectivity;
a database stored on the server, the database containing a digital inventory of gift card redemption codes corresponding to a variety of amounts and a variety of merchants, the gift card redemption codes known only by the server and the variety of merchants to which the gift card redemption codes pertain;
a purchasing agent stored on the server and communicatively coupled to the database, the purchasing agent configured to enable the server to purchase the gift card redemption codes from the variety of merchants at a variety of amounts and store the gift card redemption codes in the database;
a customer graphic user interface (GUI) hosted by the server and displayed to customers on personal web-enabled devices, the customer GUI for enabling the customers to obtain a chosen value of specific merchant credit from the server, wherein specific merchant credit corresponds to one merchant of the variety of merchants;
a credit fulfillment module, the credit fulfillment module stored on the server and communicatively coupled to the database, the credit fulfillment module for receiving notice from the one merchant that the customers intend to redeem the specific merchant credit, and fulfills the intent to redeem the specific merchant credit using the gift card redemption codes contained within the digital inventory in the database on the server; and
a database manager stored on the server and communicatively coupled to the database and the purchasing agent, the database manager for optimizing the digital inventory such that the customers do not rely upon the variety of merchants to obtain specific merchant credit and digital inventory operating costs are minimized.

2. The system of claim 1, wherein particular gift card redemption codes correspond directly to particular specific merchant credits.

3. The system of claim 1, wherein there is no association between particular gift card redemption codes and particular specific merchant credits.

4. The system of claim 1, wherein more than one gift card redemption code corresponds directly to a particular specific merchant credit.

5. The system of claim 1, wherein one gift card redemption code corresponds directly to the specific merchant credits owned by two or more customers.

6. A system comprising:
a server;
a database stored on the server, the database containing a digital inventory of gift card redemption codes corresponding to a variety of amounts and a variety of merchants, the digital inventory stored on the server;
a merchant interface instantiated on the server and communicatively coupled to the database, the merchant interface configured to enable the server to purchase the gift card redemption codes from the variety of merchants; and
a customer interface instantiated on the server and displayed to customers on personal web-enabled devices, the customer interface for enabling customers to communicate with the server and purchase rights to value represented by one or more of the gift card redemption codes from the digital inventory.

7. The system of claim 6, wherein the digital inventory is optimized with an economic order quantity of gift card redemption codes from each of the variety of merchants and each of the variety of amounts.

8. The system of claim 7, wherein the optimization of the digital inventory takes time-variable demand into account.

9. The system of claim 6, wherein the customer interface is a web application.

10. The system of claim 6, wherein the variety of merchants includes a given merchant and the customer interface provides for combining purchases of rights to two or more gift card redemption codes corresponding to the given merchant such that the two or more gift card redemption codes are represented to the customers as a single redeemable purchase.

11. The system of claim 6, wherein the rights to value represented by one or more of the gift card redemption codes from the digital inventory correspond to specific gift card redemption codes.

12. The system of claim 6, wherein the rights to value represented by one or more of the gift card redemption codes from the digital inventory do not correspond to specific gift card redemption codes.

13. The system of claim 6, wherein the digital inventory further includes that the gift card redemption codes that are directed towards a plurality of specific goods or services.

14. A method comprising:
purchasing an economic order quantity of gift card redemption codes from a plurality of merchants at a plurality of amounts;
storing the economic order quantity of gift card redemption codes on a web server;
providing instant availability for the resale of the economic order quantity of gift card redemption codes from the web server to customers through an Internet application in a single format regardless of which of the plurality of merchants the resold gift card redemption codes correspond to.

15. The method of claim 14, wherein the economic order quantity accounts for time-variable demand.

16. The method of claim 14, wherein the single format comprises account credits.

17. The method of claim 16, wherein account credits correspond indirectly to the gift card redemption codes and the web server determines how the gift card redemption codes are allocated to account credits.

18. The method of claim 14, wherein at least one of the plurality of merchants does not offer gift card redemption codes electronically or over the Internet.

19. The method of claim 14, wherein said purchasing an economic order quantity of gift card redemption codes further includes that the gift card redemption codes that are directed towards a plurality of specific goods or services.

20. A method comprising:
establishing a digital inventory of an economic order quantity of gift card redemption codes from a plurality of merchants at a plurality of amounts;
storing the economic order quantity of gift card redemption codes on a web server;
accepting purchase orders from customers for gift amounts at specified merchants of the plurality of merchants;
providing the customers with access to digital tokens with a web application as evidence of the purchase orders;
fulfilling expenditures of the gift amounts at specified merchants with the digital inventory at the discretion of the server.

21. The method of claim 20, wherein the discretion of the server of said fulfilling expenditures comprises assigning specific gift card redemption codes from the economic order quantity of gift card redemption codes to digital tokens.

22. The method of claim 21, wherein the discretion of the server of said fulfilling expenditures comprises revoking the assignment of the specific gift card redemption codes and reassigning different gift card redemption codes from the economic order quantity of gift card redemption codes to digital tokens.

23. The method of claim 20, wherein the discretion of the server of said fulfilling expenditures comprises utilizing the gift card redemption codes of the digital inventory as needed without assigning specific gift card redemption codes to the digital tokens.

24. The method of claim 20, wherein said fulfilling expenditures has an average fulfillment time, the average fulfillment time being the average time gap between said providing the customers access, and said fulfilling expenditures, wherein the economic order quantity is calculated using the average fulfillment time as a factor.
